(19) United States
(12) Patent Application Publication
(10) Pub. No.: US 2002/0084313 A1
(43) Pub. Date: Jul. 4, 2002

(54) Process for joining aluminum components by spot welding

(76) Inventor: Gregory J. Courval, Napanee (CA)

Correspondence Address: Christopher C. Dunham, c/o COOPER & DUNHAM LLP, 1185 Ave. of the Americas, New York, NY, 10036, US

(21) Appl. No.: 09/990,241

(22) Filed: Nov. 21, 2001

Related U.S. Application Data
(60) Provisional application No. 60/250,050, filed on Nov. 30, 2000.

(51) Int. Cl. B23K 1/20; B23K 31/02

(52) U.S. Cl. 228/206; 228/205

(57) ABSTRACT

A process is described for forming a structure of aluminum sheet components by spot welding the aluminum sheet components. In the process, aluminum sheet components are pretreated in a single step to both clean and increase the surface resistivity thereof by contacting the aluminum sheets with a pretreatment solution comprising a blend of sulphuric acid and phosphoric acid to clean the surface and generate a surface coating acting as a barrier film to increase the surface resistivity of the sheets. Thereafter the sheet components are secured together by spot welding.

### BACKGROUND OF THE INVENTION

This invention relates to the joining of aluminum components by spot welding, and particularly to a pretreatment of the components prior to spot welding. This application claims the benefit of U.S. Provisional Application No. 60/250,050 filed Nov. 30, 2000.

Spot welding is a joining process widely used in the automotive industry to fabricate components such as hoods, deck lids, doors and many other structural and semi-structural parts. Spot welding of aluminum alloys is well known and has been used for many years for this purpose. The surface composition of an alloy can be an important factor in determining the overall performance of the welding process and weld quality. All aluminum products are covered by a layer of oxide. The oxide is often very inhomogeneous in composition and thickness and can also contain a substantial proportion of organic residues left on the sheet surface during the rolling process. This is often the case for certain 5XXX series alloys, such as AA5182. This surface inhomogeneity and contaminants can result in poor weld quality during the spot welding process and decrease the tip life of the spot welding electrodes. The welding process thus becomes less reliable and more expensive as a result.

Cleaning of aluminum sheet is a process used to remove excess surface oxide and contaminants. The cleaning can be carried out using organic solvents, alkali and/or acid chemicals or by electrochemical processing methods. The effect of the cleaning process is not only to remove the excess oxides and debris but also to produce a new, thinner, homogeneous oxide layer on the aluminum surface. This clean surface is much more desirable for good spot welding performance since better weld quality can be obtained and there is much less transfer of contaminants onto the spot welding electrodes, hence longer tip life. There is however one drawback to a very clean aluminum surface with only a thin oxide film. A spot weld is formed due to the generation of heat at the faying aluminum surfaces when electric current is passed between the electrodes. A very thin oxide at the faying surfaces results in very low surface resistivity and hence high currents are needed to produce the weld. The need for high currents can impose certain limitations on the type of welding equipment to be used and can also result in higher costs. Therefore in the ideal situation, aluminum surfaces that are to be welded should be clean in order to remove excess oxide, contaminants and other surface inhomogeneities, but should also have a barrier film to provide a certain level of surface resistivity. This barrier film can be generated by application of certain chemical pretreatments to the aluminum surface after cleaning or by anodizing. However, the application of such processes increases the cost of the aluminum sheet product.

In Selwood et al., European Application EP 0 127 343, published Jun. 12, 1966, there is described a process for resistance spot welding aluminum sheet components in which the aluminum sheet is first cleaned with an acid or alkaline solution to remove the aluminum oxide layer, after which it is treated with a solution containing chromium ions to form a surface coating containing at least 10% by weight chromium. This surface coating preferably also contains phosphate. The surface coating thus formed is then overlayed with a coating of adhesive used to hold the components together prior to resistance spot welding.

It is an object of the present invention to provide a simple, single step procedure for both cleaning and increasing the surface resistivity of aluminum sheet components prior to spot welding.

### SUMMARY OF THE INVENTION

This invention in its broadest aspect relates to a process for forming a structure of aluminum components formed from aluminum sheet in which the aluminum sheet is pretreated in a single step to both clean and increase the surface resistivity of the sheet. This is accomplished according to the invention by treating the aluminum sheet with a blend of sulphuric acid and phosphoric acid to both clean the surface and generate a surface coating to provide a barrier film which increases the surface resistivity of the sheet. After pretreatment in the above manner, the components are secured together by spot welding.

Thus it will be seen that in accordance with the present invention, it is possible to generate a barrier film to increase the surface resistivity of the aluminum sheet and hence lower the current requirements during spot welding concurrently with the cleaning operation to remove surface contaminants. The phosphoric acid forms an essential part of the acid cleaning system used to generate the barrier film. The surface generated in the one pretreatment step therefore combines the good weld quality and long tip life characteristic of a well-cleaned surface with a thin, homogeneous oxide layer having higher surface resistivity and hence lower current demands during spot welding.

The pretreatment solution typically contains sulphuric acid in a concentration of 0.15-7.5%, preferably 0.5-5% and phosphoric acid in a concentration of 0.3-15%, preferably 0.75-10%, the concentrations being in percentages by weight. It may be applied by spraying on the aluminum sheet or by immersing the aluminum sheet in a bath of the pretreatment solution. The solution is typically left in contact with the aluminum sheet for about 1 to 60 seconds, preferably about 2 to 20 seconds. The operational temperature is typically in the range of about ambient to 100° C., preferably about 35-80° C.

Advantageously, the acid pretreatment provides an etch rate of at least 0.01 g/m² and not more than about 1.5 g/m². The aluminum sheet typically has a thickness in the range of about 0.7 to 3 mm.

### DESCRIPTION OF THE PREFERRED EMBODIMENTS

### EXAMPLE 1

Samples of AA5182 aluminum alloy sheet having a thickness of 0.90 mm were cleaned with two different treatment solutions as follows:

(a) a blend of sulphuric and hydrofluoric acid in concentrations of about 2.4% sulphuric acid and 0.2% hydrofluoric acid (as free fluoride),

(b) a blend of sulphuric and phosphoric acid in concentrations of about 3% sulphuric acid and 6.7% sulphuric acid.

The cleaning time with the above solutions varied from 10 to 24 seconds.

Both cleaned sheet materials exhibited good welding performance in terms of weld quality and tip life with oxide thicknesses of about 5 to 15 nm. However, the material treated with the sulphuric/phosphoric acid solution had a considerably higher surface resistivity (approximately 5 to 800 μohms compared to 300 to 400 μohms) than the sheet cleaned with the sulphuric/hydrofluoric acid solution. Surface resistivities were measured according to the DVS 2929 procedure of the German Welding Technology Association. (Deutscher Verband fur Schweisstechnik e.V.) The higher surface resistivity on the aluminum sheet cleaned with the sulphuric/phosphoric acid was correlated with the presence of a film of aluminum phosphate, approximately 10 nm in thickness, on the sheet surface. The welding current required for the sheet cleaned with the sulphuric/phosphoric acid solution was approximately 3 kA lower than that required for the material cleaned with the sulphuric/hydrofluoric acid.

A further sample of AA5182 sheet was treated with dilute sulphuric acid (up to 0.06 N), which produced both inferior cleaning and welding performance.

1. A process for forming a structure of aluminum components formed from aluminum sheet, which comprises pretreating aluminum sheet in a single step to both clean and increase the surface resistivity thereof by contacting the aluminum sheet with pretreatment solution comprising a blend of sulphuric acid and phosphoric acid to clean the surface and generate a surface coating acting as a barrier film to increase the surface resistivity of the sheet and thereafter securing the components together by spot welding.

2. A process according to claim 1, wherein the pretreatment solution contains about 0.15-7.5% sulphuric acid and about 0.3-15% phosphoric acid.

3. A process according to claim 2, wherein the pretreatment solution contains about 0.5-5% sulphuric acid and about 0.75-10% phosphoric acid.

4. A process according to claim 2, wherein the acid pretreatment provides an etch rate of about 0.01 to 1.5 g/m².

5. A process according to claim 4, wherein the aluminum is an alloy of the AA 5XXX series.

6. A process according to claim 4, wherein the aluminum sheet has a thickness of about 0.7 to 3 mm.
